(19) United States
(12) Patent Application Publication
(10) Pub. No.: US 2022/0337025 A1
(43) Pub. Date: Oct. 20, 2022

(54) OPTICAL AMPLIFIER

(71) Applicant: NIPPON TELEGRAPH AND TELEPHONE CORPORATION, Tokyo (JP)

(72) Inventors: Shinichi AOZASA, Musashino-shi, Tokyo (JP); Taiji SAKAMOTO, Musashino-shi, Tokyo (JP); Kazuhide NAKAJIMA, Musashino-shi, Tokyo (JP); Masaki WADA, Musashino-shi, Tokyo (JP)

(73) Assignee: NIPPON TELEGRAPH AND TELEPHONE CORPORATION, Tokyo (JP)

(21) Appl. No.: 17/762,399

(22) PCT Filed: Sep. 26, 2019
(86) PCT No.: PCT/JP2019/037911

§ 371 Date: Mar. 22, 2022

(51) Int. Cl. H01S 3/23; H01S 3/067

(52) U.S. Cl. CPC H01S 3/2316; H01S 3/06754; H01S 3/06737

(57) ABSTRACT

An objective of the present invention is to provide an optical amplifier having a cladding excitation configuration that improves amplification efficiency. The optical amplifier includes an optical amplification unit 36 in which n (n is a natural number equal to or greater than 2) amplification fibers 34 that optically amplify signal light propagating through cores with excitation light supplied to claddings and n−1 optical input/output units 35 that input/output the signal light to/from the cores and the outside of the amplification fibers 34 are connected in series such that the amplification fibers 34 and the optical input/output units 35 are disposed in an alternating manner, an excitation light generator 31 that outputs the excitation light in multi-mode, and optical multiplexer/demultiplexers 33 that cause the excitation light from the excitation light generator 31 that has been divided into two light beams to be incident on the claddings of the amplification fibers 34 disposed at both ends of the optical amplification unit 36 and cause the signal light to be input to/output from the cores of the amplification fibers 34 disposed at both ends of the optical amplification unit 36.

### TECHNICAL FIELD

The present disclosure relates to an optical amplifier disposed in an optical communication system using spatially multiplexing (multi-core or multi-mode) optical fibers.

### BACKGROUND ART

Optical amplifiers for amplifying an optical signal as it is without converting the optical signal into electricity in an optical communication system with single-mode optical fibers have been put into practical use. Spatially multiplexing optical amplifiers are expected to be used also in optical communication systems using spatially multiplexing optical fibers (see, for example, NPL 1).

A configuration in which excitation light beams are individually supplied to cores for amplification (a core excitation configuration) and a configuration in which excitation light beams are supplied to a cladding (a cladding excitation configuration) are known as configurations of spatially multiplexing optical amplifiers. The cladding excitation configuration can simultaneously amplify a plurality of spatial channels propagating through a cladding, and can be simplified compared to the core excitation configuration. Furthermore, the cladding excitation configuration is also expected to reduce power consumption compared to the configuration in which optical amplifiers for core excitation are used for the number of spatial channels (see, for example, NPL 2). In addition, the cladding excitation configuration can use a multi-mode laser diode (LD) as a light source and thus can have improved photoelectric conversion efficiency compared to a core excitation configuration that needs to use a single-mode LD as a light source.

### CITATION LIST

### Non Patent Literature

NPL 1: M. Wada et al., “Recent Progress on SDM Amplifiers”. WelE. 3, Proc. ECOC, (2018).
NPL 2. S. Jain et al., “32-core Erbium/Ytterbium Doped Multi-Core Fiber Amplifier for Next Generation Space-Division Multiplexed Transmission System”, Optics express, 25 (26), (2017).
NPL 3: K. S. Abedin et al., “Cladding-pumped erbium-doped multicore fiber amplifier”, Optics express, 20 (18), (2012).

### SUMMARY OF THE INVENTION

### Technical Problem

However, the cladding excitation configuration has a problem that the amplification efficiency is inferior to that of the core excitation configuration because, of excitation light incident on the cladding, light beams that have not been coupled to the core are not used for amplification of optical signals. For example, with respect to the 6-core EDFA described in NPL 3, the signal light output intensity of excitation light of 10.6 W is 32 mW per core, and thus the light conversion efficiency is only approximately 2%.

Therefore, in order to solve the problem described above, an objective of the present invention is to provide an optical amplifier having a cladding excitation configuration that improves amplification efficiency.

### Means for Solving the Problem

In order to achieve the objective described above, in an optical amplifier according to the present invention, excitation light remaining in the cladding of one amplification fiber is used for excitation light of the other amplification fibers that are connected to the one amplification fiber in a cascade.

Specifically, an optical amplifier according to the present invention includes: an optical amplification unit in which n (n is a natural number equal to or greater than 2) amplification fibers and n−1 optical input/output units are connected in series so as to be alternately located, the n amplification fibers being configured to optically amplify signal light propagating through cores with excitation light supplied to claddings, the n−1 optical input/output units being configured to input/output the signal light between the cores and the outside of the amplification fibers; an excitation light generator that outputs the excitation light in multi-mode; and an optical multiplexer/demultiplexer that causes the excitation light branched into two light beams and output from the excitation light generator to be incident on the claddings of the amplification fibers disposed at both ends of the optical amplification unit and inputs/outputs the signal light to/from the cores of the amplification fibers disposed at both ends of the optical amplification unit.

In the present optical amplifier, a plurality of amplification fibers are connected in series, multi-mode excitation light is incident on the cladding of a first-stage amplification fiber, and the excitation light remaining in the cladding of the first-stage amplification fiber is coupled with the cladding of the adjacent second-stage amplification fiber, without being coupled with the core, to be used for amplification in the second-stage amplification fiber. The present optical amplifier has high photoelectric conversion efficiency in a cladding excitation configuration. Furthermore, because the present optical amplifier re-uses the excitation light that has not been coupled with the core of the first-stage amplification fiber in the other amplification fibers, use efficiency of the excitation light increases, and as a result, amplification efficiency increases.

Thus, the present invention can provide an optical amplifier with the cladding excitation configuration that improves the amplification efficiency.

In the optical amplifier according to the present invention, at least one of the amplification fibers of the optical amplification unit has different amplification characteristics from the other amplification fibers described above. The amplification characteristics can be changed by adjusting a fiber length of the amplification fibers, a core/cladding area ratio, or a concentration of rare earth ions doped in the cores. By making amplification characteristics of one amplification fiber different from amplification characteristics of the other amplification fibers, it is possible to make the band for the one amplification fiber to perform optical amplification different from the band for the other amplification fibers to perform optical amplification.

In the optical amplifier according to the present invention, at least one optical input/output unit of the optical amplification unit inputs/outputs signal light having an arbitrary wavelength of the signal light to/from the amplification fibers connected to both sides of the optical input/output unit. The present optical amplifier can change the number of amplification fibers through which optical signals pass for each wavelength, and thus optical signals of wide bands can be optically amplified.

The optical amplifier according to the present invention further includes an excitation light reflector configured to reflect the excitation light that has passed through the optical amplification unit from one side to the other side of the optical multiplexer/demultiplexer to allow the excitation light to be incident on the optical amplification unit from the other side of the optical multiplexer/demultiplexer. The present optical amplifier collects the excitation light that has not been coupled with the cores in the entire optical amplification unit and causes the excitation light to be incident on the optical amplification unit again. In this manner, the present optical amplifier increases the use efficiency of the excitation light, and as a result, the amplification efficiency is increased.

The amplification fibers of the optical amplifier according to the present invention are multi-core fibers. In this case, the optical input/output unit and the optical multiplexer/demultiplexer of the optical amplification unit preferably input/output the signal light of different bands to/from adjacent cores of the amplification fibers. Inter-core crosstalk can be reduced.

The amplification fibers of the optical amplifier according to the present invention are multi-mode fibers.

Note that each of the inventions described above can be combined with each other to the extent possible.

### Effects of the Invention

The present invention can provide an optical amplifier having a cladding excitation configuration that improves amplification efficiency.

### BRIEF DESCRIPTION OF DRAWINGS

FIG. 1 is a diagram illustrating a configuration of an optical amplifier according to the present invention.

FIG. 2 is a diagram illustrating a configuration of the optical amplifier according to the present invention.

FIG. 3 is a diagram illustrating a configuration of the optical amplifier according to the present invention.

FIG. 4 is a diagram illustrating a configuration of the optical amplifier according to the present invention.

FIG. 5 is a diagram illustrating a cross section of the amplification fiber of an optical amplifier according to the present invention.

FIG. 6 is a diagram illustrating a configuration of the optical amplifier according to the present invention.

### DESCRIPTION OF EMBODIMENTS

Embodiments of the present invention will be described with reference to the accompanying drawings. The embodiments described below are examples of the present invention, and the present invention is not limited to the embodiments described below. Note that constituent components with the same reference signs in the present specification and the drawings are assumed to be the same components.

### First Embodiment

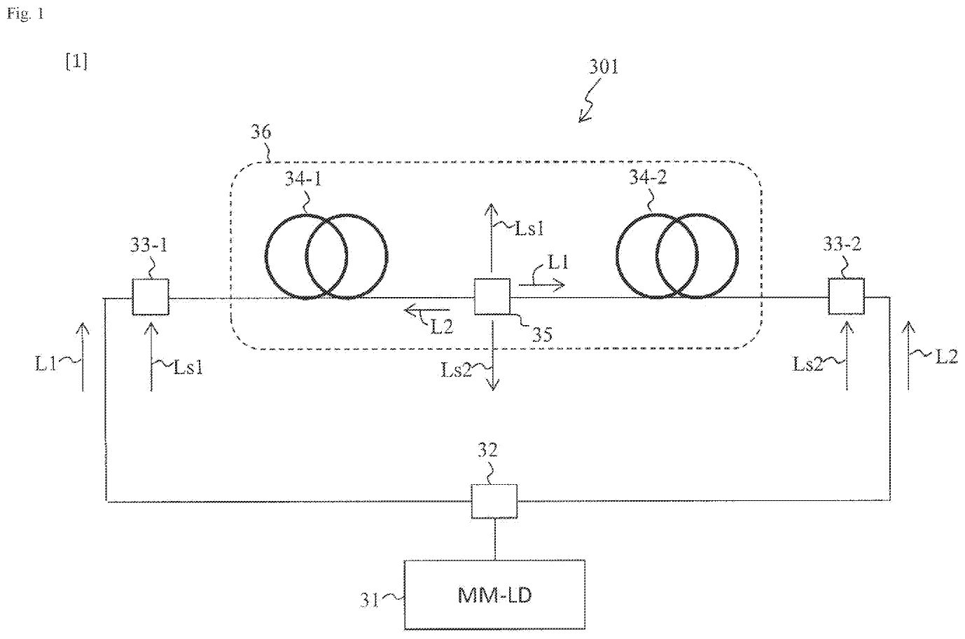

FIG. 1 is a diagram illustrating an optical amplifier 301 according to the present embodiment. The optical amplifier 301 includes an excitation light generator 31 that outputs multi-mode excitation light, an excitation light demultiplexer 32 that demultiplexes excitation light, optical multiplexers (33-1 and 33-2) that multiplex excitation light with signal light to cause the light to be incident on amplification fibers, amplification fibers (34-1 and 34-2) that amplify signal light, and an optical input/output unit 35 that outputs signal light. The optical amplifier 301 has the two amplification fibers (34-1 and 34-2) connected in series. The amplification fibers (34-1 and 34-2) are, for example, erbium-doped multi-core fibers (EDF) of which cores are doped with erbium. The optical input/output unit 35 is, for example, a dichroic mirror.

Excitation light output by the excitation light generator 31 is divided into beams passing through two paths by the excitation light demultiplexer 32. The excitation light beams on the paths are denoted by L1 and L2. The excitation light L1 is multiplexed with signal light Ls1 by the optical multiplexer 33-1 and is incident on the amplification fiber 34-1. The excitation light L2 is multiplexed with signal light Ls2 by the optical multiplexer 33-2 and is incident on the amplification fiber 34-2. Note that the signal light (Ls1 and Ls2) is incident on the cores of the amplification fibers (34-1 and 34-2), and the excitation light (L1 and L2) is incident on the claddings of the amplification fibers (34-1 and 34-2).

The signal light (Ls1 and Ls2) amplified by the amplification fibers (34-1 and 34-2) is output to each transmission line by the optical input/output unit 35. Meanwhile, a part of the excitation light L1 is partially absorbed by the amplification fiber 34-1 and the rest of the light remains. The remaining excitation light L1 is incident on the amplification fiber 34-2 from the amplification fiber 34-1 via the optical input/output unit 35 to contribute to optical amplification in the amplification fiber 34-2 along with the excitation light L2. Similarly, excitation light L2 is incident on the amplification fiber 34-1 from the amplification fiber 34-2 via the optical input/output unit 35 to contribute to optical amplification in the amplification fiber 34-1 along with the excitation light L1.

The optical amplifier 301 enables optical amplification in the two amplification fibers with excitation light output from one multi-mode excitation light source 31. Thus, the optical amplifier 301 can simplify the structure and reduce power consumption. In addition, the optical amplifier 301 can increase efficiency of optical amplification because excitation light that has propagated through one amplification fiber is coupled with the other amplification fiber to be re-used in amplification.

### Second Embodiment

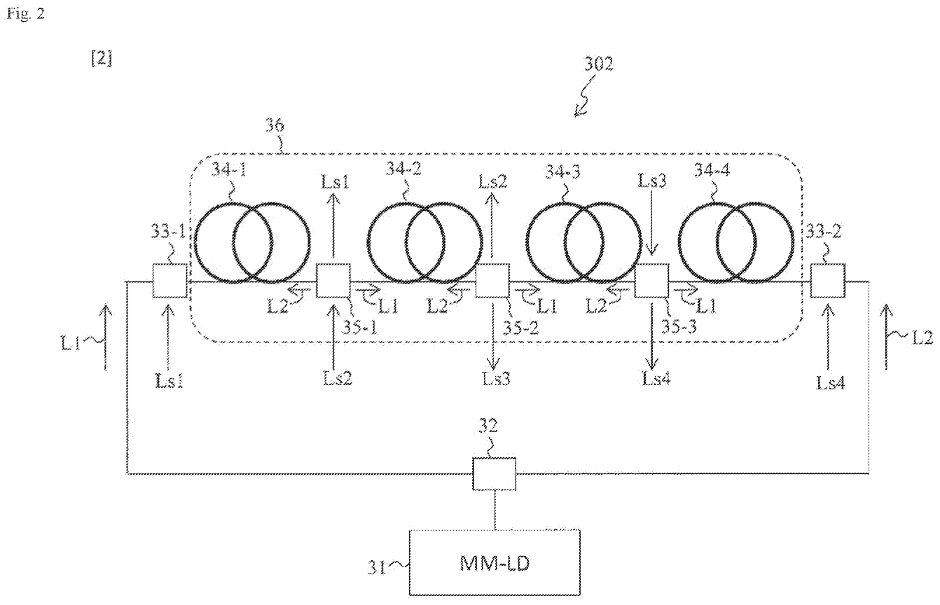

The technique described in the first embodiment can also be applied not only by connecting two amplification fibers but also by connecting n amplification fibers and n−1 optical input/output units in a cascade. FIG. 2 is a diagram illustrating an optical amplifier 302 according to the present embodiment. The optical amplifier 302 includes:

an optical amplification unit 36 that connects, in series, n (n is a natural number equal to or greater than 2) amplification fibers 34 that optically amplify signal light propagating through the cores with excitation light supplied to the claddings and n−1 optical input/output units 35 that input/output the signal light between the cores and the outside of the amplification fibers 34 such that the amplification fibers 34 and the optical input/output units 35 are disposed in an alternating manner,

an excitation light generator 31 that outputs the excitation light in multi-mode, and optical multiplexer/demultiplexers 33 that cause the excitation light branched into two light beams and output from the excitation light generator 31 to be incident on the claddings of the amplification fibers 34 disposed at both ends of the optical amplification units 36 and inputs/outputs the signal light to/from the cores of the amplification fibers 34 disposed at both ends of the optical amplification units 36.

The optical amplifier 302 is an example of n=4. Excitation light L1 is incident from the optical multiplexer/demultiplexer 33-1 and passes sequentially from the amplification fiber 34-1 to the amplification fiber 34-4 to contribute to optical amplification in each of the amplification fibers, and is output to the optical multiplexer/demultiplexer 33-2. In addition, the excitation light L2 is incident from the optical multiplexer/demultiplexer 33-2 and sequentially passes from the amplification fiber 34-4 to the amplification fiber 34-1 to contribute to optical amplification in each of the amplification fibers, and is output to the optical multiplexer/demultiplexer 33-1.

Signal light Ls1 is incident from the optical multiplexer/demultiplexer 33-1, is amplified by the amplification fiber 34-1, and is output from the optical input/output unit 35-1 to a transmission line of the signal light Ls1. Signal light Ls2 is incident from the optical input/output unit 35-1, is amplified by the amplification fiber 34-2, and is output from the optical input/output unit 35-2 to a transmission line of the signal light Ls2. Signal light Ls3 is incident from the optical input/output unit 35-3, is amplified by the amplification fiber 34-3, and is output from the optical input/output unit 35-2 to a transmission line of the signal light Ls3. Signal light Ls4 is incident from the optical multiplexer/demultiplexer 33-2, is amplified by the amplification fiber 34-4, and is output from the optical input/output unit 35-3 to a transmission line of the signal light Ls4.

The optical amplifier 302 propagates the excitation light remaining without being absorbed in each amplification fiber through the subsequent amplification fibers and reuses it for optical amplification. As a result, the optical amplifier 302 can increase use efficiency of the excitation light and thus can improve amplification efficiency.

### Third Embodiment

If amplification fibers are connected in multiple stages, amplification characteristics of each amplification fiber can be individually controlled in accordance with an optical signal to be optically amplified. The amplification characteristics can be adjusted by using a difference in length of the amplification fibers, a core/cladding area ratio, or a concentration of rare earth ions doped in the cores.

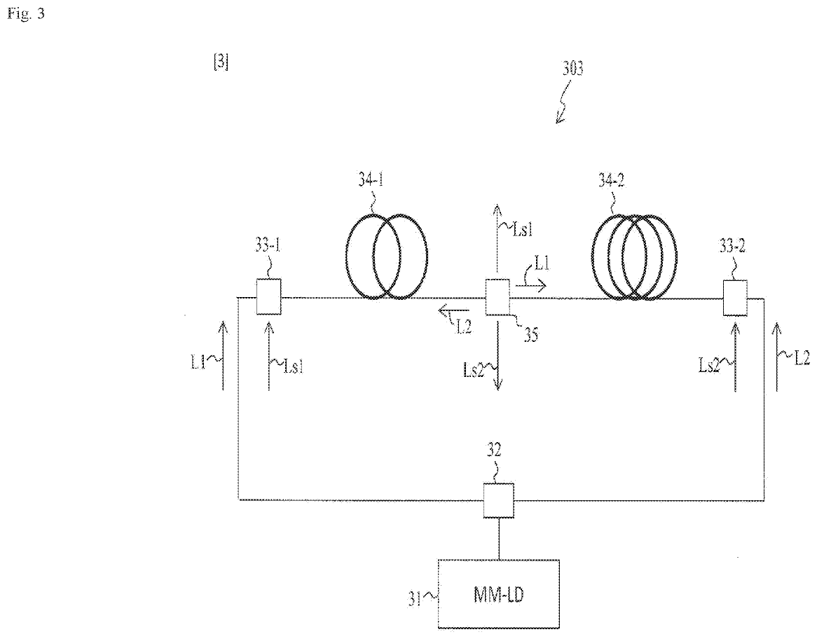

FIG. 3 is a diagram illustrating an optical amplifier 303 according to the present embodiment. The optical amplifier 303 is different from the optical amplifier 301 of FIG. 1 in that at least one amplification fiber of the optical amplification unit 36 has different amplification characteristics from the other amplification fibers. Specifically, the optical amplifier 303 has an amplification fiber 34-2 that is longer than an amplification fiber 34-1. An EDF enables amplification of not only light of a C band (1530 to 1565 nm) but also light of an L band (1565 to 1605 nm) depending on a length. Thus, the optical amplifier 303 amplifies the signal light Ls1 of the C band with the amplification fiber 34-1, and amplifies the signal light Ls2 of the L band with the amplification fiber 34-2.

Likewise, the optical amplifier 302 of FIG. 2 can amplify signal light of various bands by adjusting the length of each amplification fiber. In addition, although the amplification characteristics are changed by making the lengths of the amplification fibers different from each other in the present embodiment, the amplification characteristics can also be changed by changing the core/cladding area ratio and the concentration of rare earth ions.

### Fourth Embodiment

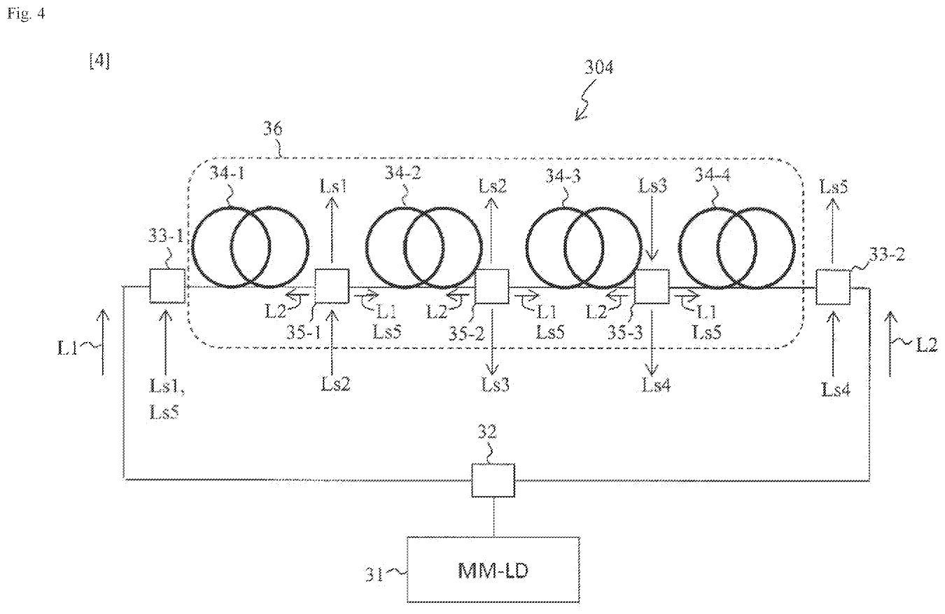

FIG. 4 is a diagram illustrating an optical amplifier 304 according to the present embodiment. The optical amplifier 304 is different from the optical amplifier 302 of FIG. 2 in that at least one optical input/output unit of the optical amplification unit 36 inputs/outputs signal light having an arbitrary wavelength of signal light to/from the amplification fibers connected to both sides of the optical input/output unit.

Optical input/output units (35-1, 35-2, and 35-3) in FIG. 4 transmit not only the excitation light band but also an S band (1460 to 1530 nm). Signal light (Ls1 to Ls4) is of a C band and signal light Ls5 is of an S band. Signal light (Ls1 to Ls4) is as illustrated in FIG. 2. The signal light Ls5 is incident from an optical multiplexer/demultiplexer 33-1, is amplified by an amplification fiber 34-1, is transmitted through an optical input/output unit 35-1, is coupled with an amplification fiber 34-2, and is also amplified by the amplification fiber 34-2. The signal light Ls5 amplified by the amplification fiber 34-2 is similarly amplified in amplification fibers (34-2 to 34-4) in order, and is output from an optical multiplexer/demultiplexer 33-2 to a transmission line of the signal light Ls5. In this manner, the optical amplifier 304 can amplify not only light of the C band but also light of the S band.

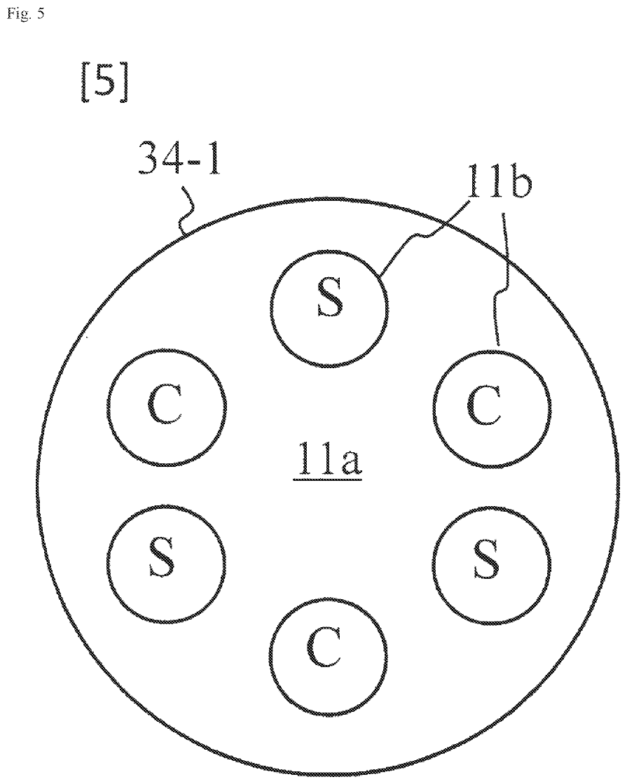

If the amplification fibers are multi-core fibers, the optical amplifier 304 may assign a band of an optical signal to each core for amplification, or may assign optical signals of a plurality of bands to one core for simultaneous amplification. If a band of an optical signal is assigned to each core, it is preferred that optical signals of different bands can propagate through adjacent cores, as illustrated in FIG. 5. Specifically, optical signals of the S band and C band may propagate through different cores. By configuring in this manner, requirements for inter-core crosstalk can be alleviated, and the distance between cores can be reduced. That is, by propagating optical signals of different bands through adjacent cores, a density of excitation light can be increased by reducing the cladding region through which the excitation light propagates, and thus amplification efficiency can be further improved.

### Fifth Embodiment

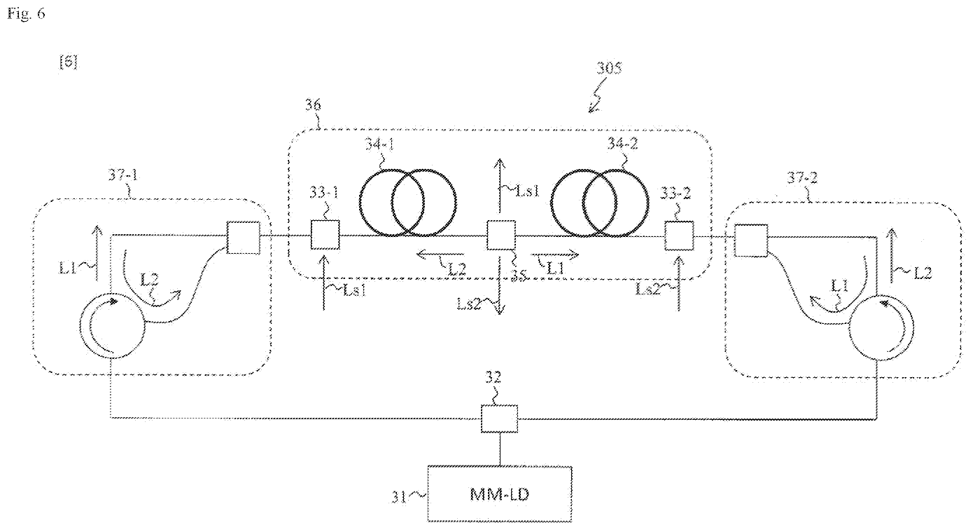

FIG. 6 is a diagram illustrating an optical amplifier 305 according to the present embodiment. The optical amplifier 305 is different from the optical amplifier 301 of FIG. 1 in that the optical amplifier 305 further includes excitation light reflectors 37 that reflect excitation light that has passed through an optical amplification unit 36 from one side to the other side of an optical multiplexer/demultiplexer to cause the excitation light to be incident on the optical amplification unit 36 from the other side of the optical multiplexer/demultiplexer.

While an excitation light reflector 37-1 causes excitation light L1 from an excitation light demultiplexer 32 to be incident on an optical multiplexer 33-1, the excitation light reflector 37-1 collects excitation light L2 remaining without being coupled with the core in the optical amplification unit 36 and output from the optical multiplexer 33-1, and causes the excitation light L2 to be incident on the optical multiplexer 33-1 again along with the excitation light L1. An excitation light reflector 37-2 also collects the excitation light L1 output from an optical multiplexer 33-2 and causes the excitation light L1 to be incident on the optical multiplexer 33-2 again along with the excitation light L2. The excitation light reflectors (37-1 and 37-2) are constituted by, for example, a multi-mode circulator and an excitation light multiplexer.

With such a configuration, it is possible to use the excitation light generated by an excitation light generator 31 for optical amplification without being discarded, and the amplification efficiency can be improved.

### Other Embodiments

Although the amplification fibers have been described as multi-core fibers in the embodiments described above, similar effects can be obtained even if the amplification fibers are multi-mode fibers.

### Additional Description

Hereinafter, an optical amplifier according to the present embodiment will be described.
(1): The present optical amplifier includes
n amplification fibers having a first cladding in which one or a plurality of cores doped with rare earth (Er, Pr, Tm, or Nd) ions are disposed, and a second cladding for confining excitation light outside the first cladding.
n−1 signal light extractors disposed between the n amplification fibers to extract only signal light amplified by the amplification fibers,
an excitation light generator for generating excitation light, and
an excitation light multiplexing unit for coupling excitation light with an amplification fiber from a preceding stage or from preceding and subsequent stages of the amplifier.
(2): In the optical amplifier according to (1) described above,
the n amplification fibers are composed of two or more types of amplification fibers having different amplification bands.
(3): In the optical amplifier according to (1) and (2) described above,
the n amplification fibers have different lengths, rare earth doping concentrations, and core/cladding area ratios.
(4): In the optical amplifier according to (1) to (3) described above,
the signal light extractors have a function of causing signal light to be incident on adjacent amplification fibers without extracting only signal light having a specific wavelength.
(5): In the optical amplifier according to (3) described above,
the cores for amplifying different bands are disposed alternately.
(6): The optical amplifier according to (1) to (3) described above has a function of collecting excitation light that has leaked after propagating through the amplification fibers and causing the excitation light to be incident on the amplification fibers again.
(7): In the optical amplifier according to (1) to (6) described above,
the amplification optical fibers have a multi-core structure.
(8): In the optical amplifier according to (1) to (6) described above,
the amplification optical fibers have a multi-mode structure.

The present optical amplifier has the following effects and features.

(a) The present optical amplifier uses cladding excitation light remaining in the amplifier for amplification of different signal light amplification fibers connected in a cascade.
(b) The present invention provides a highly efficient optical amplifier and can achieve high capacity transmission over a long distance with lower power consumption, compared to conventionally used optical amplification techniques.

### REFERENCE SIGNS LIST

11a Cladding
11b Core
31 Excitation light generator
32 Excitation light demultiplexer
33-1, 33-2 Optical multiplexer
34-1, 34-2, . . . , 34-n Amplification fiber
35, 35-1, 35-2 . . . . , 35-n−1 Optical input/output unit
36 Optical amplification unit
37, 37-1, 37-2 Excitation light reflector

1. An optical amplifier, comprising:
an optical amplification unit configured to connect, in series, n (n is a natural number equal to or greater than 2) amplification fibers each of which optically amplifies signal light propagating through a core with excitation light supplied to a cladding and n−1 optical input/output units each of which inputs/outputs the signal light between the core and outside of the amplification fiber, such that the n amplification fibers and the n−1 optical input/output units are alternately disposed;
an excitation light generator configured to output the excitation light in multi-mode; and
an optical multiplexer/demultiplexer configured to cause the excitation light to be incident on the cladding of each of the amplification fibers disposed at both ends of the optical amplification unit and to input/output the signal light to/from the core of each of the amplification fibers disposed at both ends of the optical amplification unit, the excitation light being branched into two light beams and output from the excitation light generator.

2. The optical amplifier according to claim 1, wherein at least one of the n amplification fibers of the optical amplification unit has a different amplification characteristic from another amplification fiber of the n amplification fibers.

3. The optical amplifier according to claim 1,
wherein at least one of the n−1 optical input/output unit of the optical amplification unit inputs/outputs signal light having an arbitrary wavelength of the signal light between the amplification fibers connected to both sides of the optical input/output unit.

4. The optical amplifier according to claim 1, further comprising:
an excitation light reflector configured to reflect the excitation light that has passed through the optical amplification unit from one side to another side of the optical multiplexer/demultiplexer to cause the excitation light to be incident on the optical amplification unit from the another side of the optical multiplexer/demultiplexer.

5. The optical amplifier according to claim 1,
wherein the amplification fiber is a multi-core fiber.

6. The optical amplifier according to claim 5,
wherein the optical input/output unit and the optical multiplexer/demultiplexer of the optical amplification unit input/output the signal light of a different band to/from a core adjacent to the amplification fiber.

7. The optical amplifier according to claim 1,
wherein the amplification fiber is a multi-mode fiber.
